(19) United States
(12) Patent Application Publication
(10) Pub. No.: US 2009/0021545 A1
(43) Pub. Date: Jan. 22, 2009

(54) IMAGE FORMING APPARATUS AND METHOD OF GENERATING OUTPUT SIGNAL THEREOF

(75) Inventor: Sang-youn SHIN, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co. Ltd., Suwon-si (KR)

(21) Appl. No.: 12/025,123

(22) Filed: Feb. 4, 2008

(30) Foreign Application Priority Data
Jul. 19, 2007 (KR) 2007-72134

(51) Int. Cl. B41J 29/38

(52) U.S. Cl. 347/11

(57) ABSTRACT

An image forming apparatus includes a clock generation unit to generate a plurality of unit pulse signals having frequencies which are multiples of a reference clock signal when print data having a higher resolution than a reference resolution is inputted to the image forming apparatus; and an output signal generation unit to divide the print data into plural units by applying the plurality of unit pulse signals to the print data, to detect successive pixels neighboring each other at a boundary between two of the respective units of print data, and to generate an output signal so that the successive pixels detected at the boundary form one dot.

### CROSS-REFERENCE TO RELATED APPLICATION

This application claims the benefit of Korean Application No. 2007-72134, filed Jul. 19, 2007 in the Korean Intellectual Property Office, the disclosure of which is incorporated herein by reference.

### BACKGROUND OF THE INVENTION

1. Field of the Invention

Aspects of the present invention relate to an image forming apparatus and a method of generating an output signal thereof. More particularly, aspects of the present invention relate to an image forming apparatus and a method of generating an output signal thereof which improves the quality of an image by applying a masking signal to a fixed pattern of input print data of a high resolution.

2. Description of the Related Art

Generally, a laser printer prints an image based on input print data by spraying toner on a latent image that is formed on a photoconductive drum. The latent image is formed by laser beams emitted from laser diodes corresponding to an image signal of the input print data. Once the latent image is formed, the laser printer then transfers a toner image to a print medium such as a sheet of paper.

Recently, with the developments of computer applications which enable high-resolution color printing and other types of high-resolution printing, processing of print data of a high resolution has been increasingly performed.

However, if a reference resolution that can be supported by an engine unit of an image forming apparatus is lower than the resolution of input print data, a brightness deviation occurs in pixel positions where successive data values of “1” exist as shown in FIGS. 1A-1D. An output pulse signal shown in FIG. 1C is output based on a comparison between a reference clock signal shown in FIG. 1A and input high-resolution print data shown in FIG. 1B. When successive data values of “1” neighbor each other at a boundary between two different data unit blocks, two small dots are formed, as shown in FIG. 1D. These two small dots differ in brightness compared to the one large dot shown by successive data values of “1” in the same block, and this causes the print quality to deteriorate.

### SUMMARY OF THE INVENTION

Aspects of the present invention relate to an image forming apparatus and a method of generating an output signal thereof, which improves the quality of an image by forming a dot having a fixed size by applying a masking signal to a fixed pattern of input print data having a high resolution.

The foregoing and/or other aspects and advantages are substantially realized by providing an image forming apparatus which includes a clock generation unit to generate a plurality of unit pulse signals having frequencies which are multiples of a reference clock signal when print data having a higher resolution than a reference resolution is inputted to the image forming apparatus; and an output signal generation unit to divide the print data into plural units by applying the plurality of unit pulse signals to the print data, to detect successive pixels neighboring each other at a boundary between two of the respective units of print data, and to generate an output signal so that the successive pixels detected at the boundary form one dot.

According to an aspect of the present invention, the plurality of unit pulse signals comprises a first unit pulse signal having a frequency that is ½ times a frequency of the reference clock signal, a second unit pulse signal obtained by delaying the first unit pulse signal by a ½ period of the reference clock signal, and a third unit pulse signal having a frequency that is four times the frequency of the reference clock signal.

According to an aspect of the present invention, the output signal generation unit generates the output signal by generating a masking signal to form the successive pixels into the one dot and then applying the masking signal to the print data.

According to an aspect of the present invention, the output signal generation unit determines a start position, an end position, and a size of the masking signal by applying the first and second unit pulse signals to the print data, detecting the successive pixels neighboring each other at the boundary between the two respective units of print data, applying the third unit pulse signal to the print data and counting the number of clock cycles of the third unit pulse signal up to the start and the end positions of the detected pixels.

According to an aspect of the present invention, the output signal generation unit generates the output signal by transmitting the masking signal and the print data through an OR-gate.

According to an aspect of the present invention, the output signal generation unit generates the output signal by applying the first and second unit pulse signals to the print data, generating masking signals for the first and second unit pulse signals, and then applying the respective masking signals to the print data.

According to another aspect of the present invention, a method of generating an output signal of an image forming apparatus includes generating a plurality of unit pulse signals having frequencies which are multiples of a reference clock signal when print data having a higher resolution than a reference resolution is inputted, dividing the print data into plural units by applying the plurality of unit pulse signals to the print data, detecting successive pixels neighboring each other at a boundary between two of the respective units of print data, and generating an output signal so that the successive pixels detected at the boundary form one dot.

According to another aspect of the present invention, the generating of the plurality of unit pulse signals includes generating a first unit pulse signal having a frequency that is ½ times a frequency of the reference clock signal, a second unit pulse signal obtained by delaying the first unit pulse signal by a ½ period of the reference clock signal, and a third unit pulse signal having a frequency that is four times the frequency of the reference clock signal.

According to another aspect of the present invention, the generating of the output signal includes generating a masking signal to form the successive pixels into the one dot and then applying the masking signal to the print data.

According to another aspect of the present invention, the generating of the output signal includes determining a start position, an end position and a size of the masking signal by applying the first and second unit pulse signals to the print data, detecting the successive pixels neighboring each other at the boundary between the two respective units of the print data using the applied first and second unit pulse signals, applying the third unit pulse signal to the print data, and counting the number of clock cycles of the third unit pulse signal up to the start and the end positions of the detected pixels.

According to another aspect of the present invention, the generating of the output signal includes transmitting the masking signal and the print data through an OR-gate.

According to another aspect of the present invention, the generating of the output signal includes applying the first and second unit pulse signals to the print data, generating masking signals for the first to third unit pulse signals, and then applying the respective masking signals to the print data.

According to still another aspect of the present invention, an image forming apparatus includes an image controller to generate an output signal by applying a masking signal to print data having a higher resolution than a reference resolution when the print data is inputted to the image forming apparatus, and an engine unit to print successive pixels neighboring each other at a boundary between respective units of the print data, in accordance with the generated output signal, as one dot.

According to still another aspect of the present invention, the image controller divides the print data into the respective units of the print data by applying a plurality of unit pulse signals to the print data, and detects the successive pixels neighboring each other at the boundary between the respective units of the print data.

According to still another aspect of the present invention, the image controller generates the output signal by generating a masking signal for the detected successive pixels and then transmitting the generated masking signal and the print data through an OR-gate.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A-1D are views illustrating outputs for high-resolution print data of a conventional image forming apparatus;

FIG. 2 is a block diagram illustrating the construction of an image forming apparatus according to an embodiment of the present invention;

FIG. 3 is a block diagram illustrating the detailed construction of the image forming apparatus shown in FIG. 2;

FIGS. 4A-4K are waveform diagrams illustrating a process of generating an output signal of an image forming apparatus according to an embodiment of the present invention;

FIGS. 5A-5J are waveform diagrams illustrating a process of generating a masking signal of an image forming apparatus according to an embodiment of the present invention;

FIG. 6 is a flowchart illustrating a method of generating an output signal of an image forming apparatus according to an embodiment of the present invention; and

FIG. 7 is a flowchart illustrating in detail the method of generating the output pulse signal as illustrated in operation S630 of FIG. 6.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

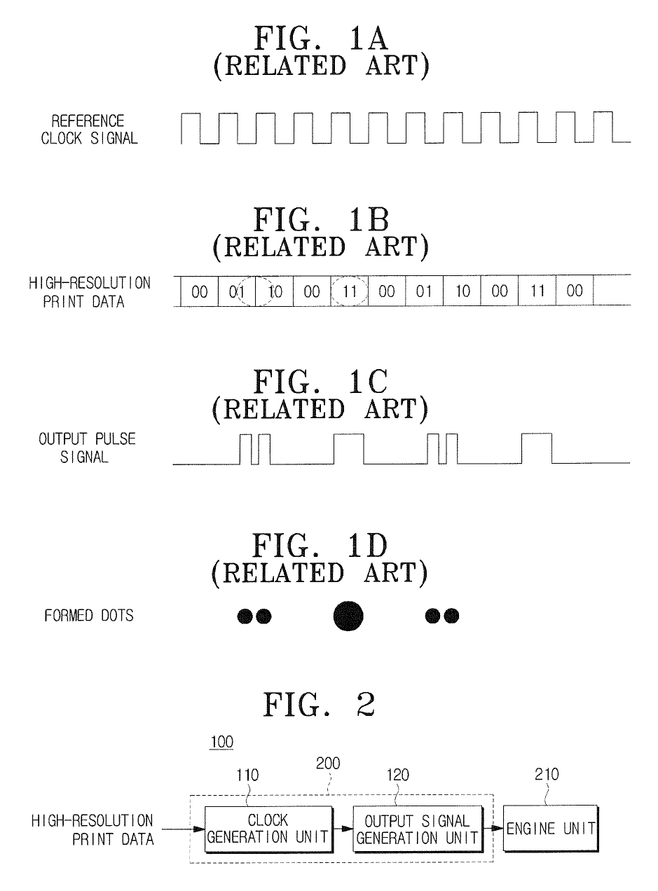

FIG. 2 is a block diagram illustrating the construction of an image forming apparatus according to an embodiment of the present invention. Referring to FIG. 2, the image forming apparatus 100 according to an embodiment of the present invention includes an image controller 200 provided with a clock generation unit 110 and an output signal generation unit 120, and an engine unit 210. Here, the image forming apparatus 100 has a reference resolution in that one pulse signal is generated for one period of a reference clock signal.

The clock generation unit 110 generates a plurality of unit pulse signals having frequencies that are specified multiples, such as ¼, 1/2, etc., of the reference clock signal when print data having a higher resolution than the reference resolution is inputted. According to an aspect of the present invention, a ½-time clock signal having a frequency that is ½ times a frequency of the reference clock signal (hereinafter referred to as a “first unit pulse signal”), a delayed ½-time clock signal obtained by delaying the ½-time clock signal by a half period (hereinafter referred to as a “second unit pulse signal”), and a four-time clock signal having a frequency that is four times a frequency of the reference clock signal (hereinafter referred to as a “third unit pulse signal”), may be used as unit pulse signals.

The output signal generation unit 120 divides the print data into plural units of print data by applying the plurality of unit pulse signals to the print data. Here, each unit of print data may have a number of pixel values inputted for one period of the reference clock signal. Specifically, when the print data of a high resolution that is twice the reference resolution is inputted, each unit print data has two pixel values each represented by a number, i.e., “1” or “0.” However, it is understood that aspects of the present invention are not limited thereto, and that each unit of print data may be more or less than the number of pixel values inputted for one period of the reference clock signal, for example, for two periods of the reference clock signal. According to an aspect, a pixel value of “1,” i.e., a pixel, corresponds to a pixel to be printed, and a pixel value of “0” corresponds to a blank space. However, it is understood that the “1” and “0” can be reversed.

The output signal generation unit 120 detects successive pixel values of “1” corresponding to pixels to be printed which are located on boundaries between the respective divided unit print data, and generates an output signal so that the detected pixels form one dot. For example, if the input print data has a high resolution that is twice the reference resolution and the print data value is “00011000,” the print data is divided into respective units of print data “00,” “01,” “10,” and “00.”

Here, in the case of the units of print data “01” and “10”, it is considered that the successive pixel values of “1,” i.e., pixels, exist on the boundary between the unit print data. These two units of print data detected by the output signal generation unit 120 are referred to as “print data to be compensated for.”

The output signal generation unit 120 generates the output signal for the high-resolution print data by applying a masking signal, which makes it possible to output successive pulse signals, to the print data to be compensated for. Here, the output signal generation unit 120 generates the successive pulse signals, i.e., the output signal, by transmitting the print data through an OR-gate to be compensated for and the masking signal.

According to an aspect of the present invention, the engine unit 210 is a laser scanning unit (LSU) that receives the output signal from the output signal generation unit 120, and forms a latent image on a photosensitive medium, such as, for example, an organic photoconductive (OPC) drum, which then transfers the latent image to a printing medium, such as a sheet of paper, a transparency sheet, stationary, etc. The engine unit forms a dot having a fixed size with respect to the same pixel of the print data. It is understood that other types of photosensitive media can be used, such as intermediate transfer belts, etc.

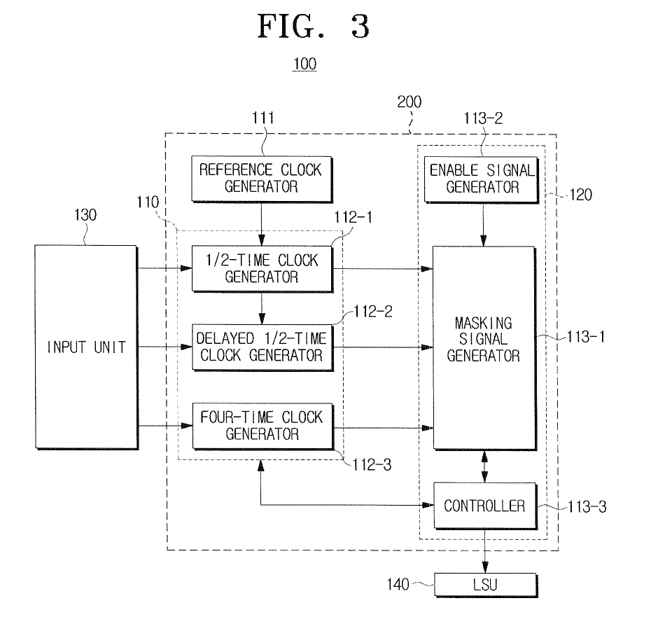

FIG. 3 is a block diagram illustrating the detailed construction of the image forming apparatus of FIG. 2. Referring to FIG. 3, the image forming apparatus 100 further includes an input unit 130. In addition, the clock generation unit 110 includes a reference clock generator 111, a ½-time clock generator 112-1, a delayed ½-time clock generator 112-2, and a four-time clock generator 112-3. The output signal generation unit 120 includes a masking signal generator 113-1, an enable signal generator 113-2, and a controller 113-1.

The input unit 130 receives the print data. According to an aspect of the present invention, the input print data may be print data having a higher resolution than the reference resolution of the image forming apparatus 100. Here, it is exemplified that the print data has a high resolution that is twice the reference resolution of the image forming apparatus 100. However, it is understood that the image forming apparatus 100 according to other aspects of the present invention may also function with input print data which is more than twice the reference resolution of the image forming apparatus 100, such as 3×, 4×, 5×, . . . 10× . . . , etc.

The ½-time clock generator 112-1 generates a first unit pulse signal having a frequency that is ½ times the reference clock signal. The delayed ½-time clock generator 112-2 generates a second unit pulse signal obtained by delaying the first unit pulse signal by a ½ period. The four-time clock generator 112-3 generates a third unit pulse signal having a frequency that is four times the reference clock signal.

The controller 113-3 divides the input print data into respective print data by applying in parallel the first and second unit pulse signals generated by the ½-time clock generator 112-1 and the delayed ½-time clock generator, respectively, to the input print data. After applying the first and second unit pulse signals, the controller 113-3 detects successive pulse signals generated on the boundaries between the unit print data.

The masking signal generator 113-1 generates a masking signal to form the detected pulse signals into one dot. At this time, the masking signal generator 113-1 generates the masking signal using the four-time clock frequency. It is understood, however, that the masking signal generator 113-1 may instead use frequencies other than four-times, such as eight times, etc. The masking signal generator 113-1 determines the position and the size of the masking signal by applying the first and second unit pulse signals to the print data, detecting the successive pixel values of “1,” i.e., pixels, existing on the boundaries of the respective unit print data, applying the third unit pulse signal to the print data and then counting the number of clock cycles, i.e., periods, of the third unit pulse signal up to the positions of the successive pixel values of “1” existing on the boundaries between the respective unit print data.

The enable signal generator 113-2 generates an enable signal to determine an enable state of the masking signal at the position of the masking signal determined by the masking signal generator 113-1.

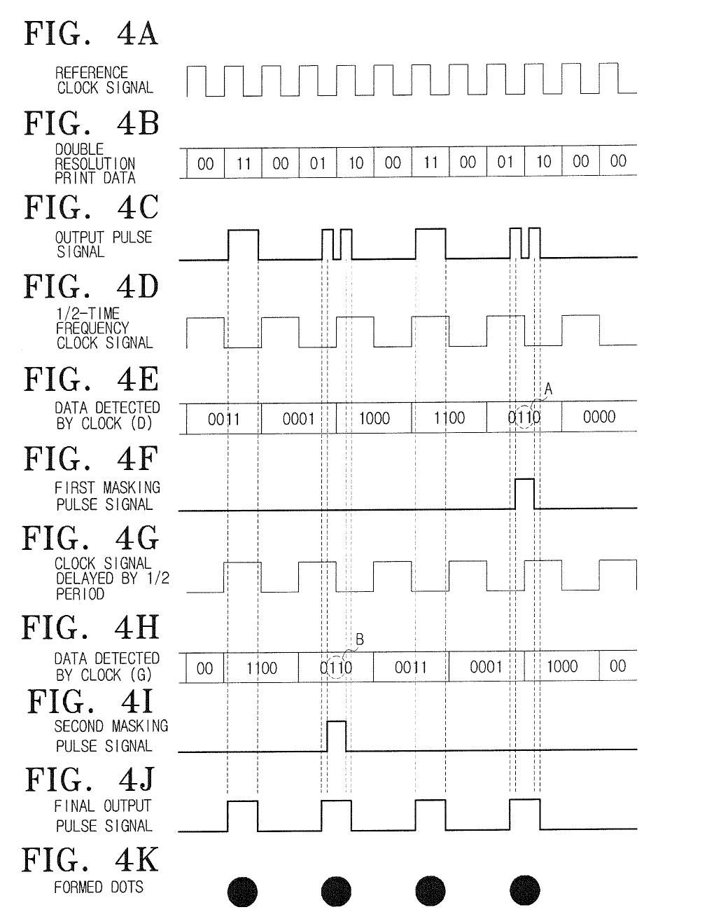

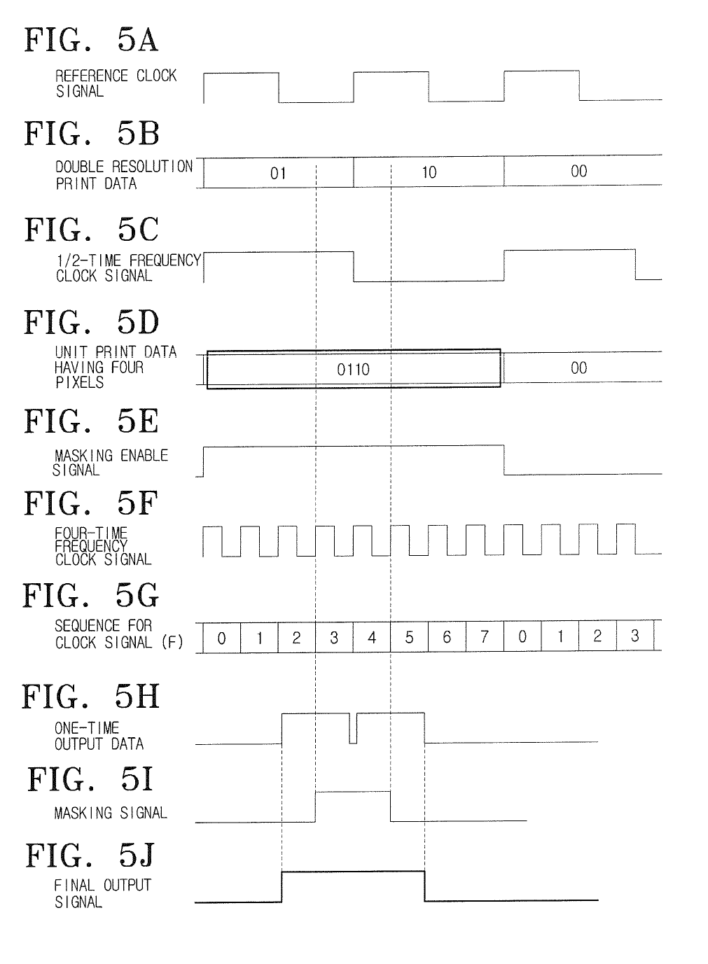

The controller 113-3 receives the print data inputted through the input unit and the masking signal generated from the masking signal generator 113-1, and generates the output signal by transmitting the print data and the masking signal through an OR-gate. In addition, the controller 113-3 applies the generated output signal to the LSU 140, and controls the LSU 140 to form the successive pixels neighboring each other at the boundaries between the respective units of print data into one dot. The process of generating the output signal will be described with reference to FIGS. 4 and 5.

FIGS. 4A-K are waveform diagrams illustrating a process of generating an output signal of an image forming apparatus according to an embodiment of the present invention. If the double resolution print data shown in FIG. 4B having a resolution that is twice the reference clock signal shown in FIG. 4A is outputted without applying the masking signal thereto, a pulse signal shown in FIG. 4C is outputted. Accordingly, the print data is divided into respective units of print data by applying a ½-time frequency clock signal shown in FIG. 4D and a half-period-delayed ½-time frequency clock signal shown in FIG. 4G to the print data shown in FIG. 4B.

If successive pixel values A (FIG. 4E) and B (FIG. 4G) are detected while an output pulse signal for the print data is generated by applying the clock signals shown in FIG. 4D and FIG. 4G along scanning lines, masking signals shown in FIG. 4F and FIG. 41 for the respective pixel values are transmitted through an OR-gate to generate a final output pulse signal shown in FIG. 4J. Accordingly, the dots shown in FIG. 4K for the same pixel values are formed with a fixed size.

The generation of the masking signals shown in FIG. 4F and FIG. 41 will be described in detail with reference to FIGS. 5A-J. FIGS. 5A-5J are waveform diagrams illustrating a process of generating a masking signal of an image forming apparatus according to an embodiment of the present invention.

Referring to FIGS. 5A-J, the four-time frequency clock signal shown in FIG. 5F and a sequence for the four-time frequency clock signal shown in FIG. 5G obtained by counting the ½-time frequency clock signal shown in FIG. 5C using the four-time frequency clock signal shown in FIG. 5F can be obtained. According to an aspect of the present invention, one period of the unit print data shown in FIG. 5D is divided by the ½-time frequency clock signal shown in FIG. 5C and has four pixels. The unit print data is counted in the unit of one period of the clock signal shown in FIG. 5F by applying the four-time frequency clock signal shown in FIG. 4F thereto. Here, a masking signal shown in FIG. 51 having a pulse width that starts from a start position indicated by an end of sequence “2” of a position detected as successive data regions and ends at an end position indicated by an end of sequence “4” is generated.

In FIG. 5C, it is exemplified that the masking signal for the ½-time frequency clock signal is generated. However, the masking signal for the delayed ½-time frequency clock signal may be generated in substantially the same manner. Additionally, masking signals for frequency clock signals other than ½-time and delayed ½-time frequency clock signals may also be generated in substantially the same manner.

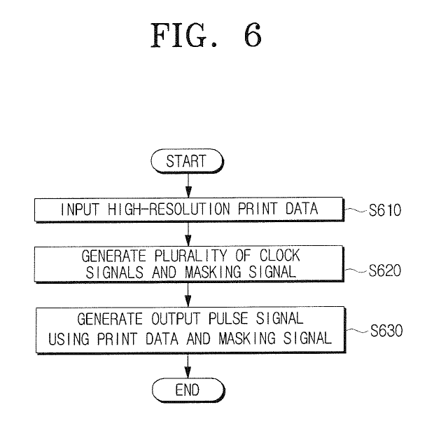

FIG. 6 is a flowchart illustrating a method of generating an output signal according to an embodiment of the present invention. Referring to FIG. 6, Print data having a high resolution is inputted into the image forming apparatus 100 in operation S610. At operation S620, a plurality of unit pulse signals having frequencies that are specified multiples of a reference clock signal and masking signals are generated. According to an aspect of the present invention, the unit pulse signals include a first unit pulse signal having a frequency that is ½ of the reference clock signal, a second unit pulse signal obtained by delaying the first unit pulse signal by a ½ period, and a third unit pulse signal having a frequency that is four times the reference clock signal.

Then, the print data is divided into plural units of print data by applying the plurality of unit pulse signals to the print data. According to an aspect of the present invention, each unit of print data may have pixel values of the print data inputted for a period of the reference clock signal. For example, when the print data having a high resolution that is twice the reference resolution is inputted, each unit of print data may have two pixel values. According to an aspect, a pixel value of “1,” i.e., a pixel, corresponds to a pixel to be printed, and a pixel value of “0” corresponds to a blank space. However, it is understood that the “1” and “0” can be reversed.

At operation S630, successive pixel values of “1” existing on boundaries between the respective units of print data are detected, and an output signal obtained by transmitting the print data and the masking signal through an OR-gate is generated so that the detected pixels form one dot. For example, if the input print data has a high resolution that is twice the reference resolution and the print data value is “00011000”, the print data is divided into respective units of print data “00,” “01,” “10,” and “00.” Here, in the case of the unit print data “01” and “10,” it is considered that the successive pixel values of “1” exist on the boundary between the unit print data. The output signal for the high-resolution print data is generated by applying the masking signal, which makes it possible to output successive pulse signals, to the detected unit print data.

In FIGS. 4A-4K and 5A-5J, it is exemplified that the print data having a frequency that is twice the reference pulse signal is inputted. However, print data having frequencies other than the frequency that is twice the reference pulse signal can also be processed in the same manner, such as ½ of the reference pulse signal, ¼ of the reference pulse signal, etc.

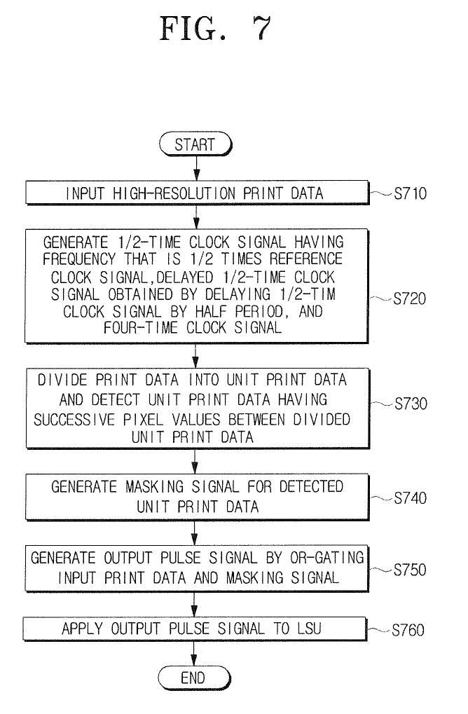

FIG. 7 is a flowchart illustrating in detail the method of generating the output pulse signal as illustrated in operation S630 of FIG. 6. Referring to FIG. 7, print data having a high resolution that is twice the reference pulse signal is inputted to the image forming apparatus 100 in operation S710. Although it is exemplified that the print data having a high resolution that is twice the reference resolution of the image forming apparatus 100 is processed, it is understood that print data having resolutions other than twice the reference resolution of the image forming apparatus 100 may also be used according to aspects of the present invention, such as 4×, 8×, etc.

A ½-time clock signal having a frequency that is ½ times the reference clock signal, a delayed ½-time clock signal obtained by delaying the ½-time clock signal by a ½ period, and a four-time clock signal having a frequency that is four times the reference clock signal are generated in operation S720. The input print data is divided into respective units of print data by applying in parallel the ½-time clock signal and the delayed ½-time clock signal, i.e., first and second unit pulse signals, to the input print data, and the units of print data having successive pixel values of “1” on the boundaries between the units of print data are detected in operation S730.

Then, a masking signal to form the detected pulse signals into one dot is generated in operation S740. According to an aspect of the present invention, the masking signal is generated using a four-time clock frequency. The position and the size of the masking signal are determined by counting the number of clocks up to the positions of the successive pixel values of “1” existing on the boundaries between the respective units of print data by applying the four-time clock signal to the print data. It is understood that the masking signal may instead be generated using a different clock frequency, such as six-time, eight-time, etc.

The output signal is generated by transmitting the input print data and the masking signal through an OR-gate in operation S750. The generated output pulse signal is applied to the LSU in operation S760. The laser scanning unit (LSU) is controlled to form the successive pixels existing on the boundaries of the respective units of print data into one dot.

As described above, according to aspects of the present invention, the brightness deviation between dots formed by a laser scanning unit (LSU) is removed by applying a masking signal to a fixed pattern of input print data having a high resolution. Thus, aspects of the present invention improve the quality of an image based on high resolution print data.

Although a few aspects of the present invention have been shown and described, it would be appreciated by those skilled in the art that changes may be made without departing from the principles and spirit of the invention, the scope of which is defined in the claims and their equivalents.

What is claimed is:

1. An image forming apparatus comprising:
a clock generation unit to generate a plurality of unit pulse signals having frequencies which are multiples of a reference clock signal when print data having a higher resolution than a reference resolution is inputted to the image forming apparatus; and
an output signal generation unit to divide the print data into plural units by applying the plurality of unit pulse signals to the print data, to detect successive pixels neighboring each other at a boundary between two of the respective units of print data, and to generate an output signal so that the successive pixels detected at the boundary form one dot.

2. The image forming apparatus of claim 1, wherein the plurality of unit pulse signals comprises a first unit pulse signal having a frequency that is ½ times a frequency of the reference clock signal, a second unit pulse signal obtained by delaying the first unit pulse signal by a ½ period of the reference clock signal, and a third unit pulse signal having a frequency that is four times the frequency of the reference clock signal.

3. The image forming apparatus of claim 2, wherein the output signal generation unit generates the output signal by generating a masking signal to form the successive pixels into the one dot and then applying the masking signal to the print data.

4. The image forming apparatus of claim 3, wherein the output signal generation unit determines a start position, an end position, and a size of the masking signal by applying the first and second unit pulse signals to the print data, detecting the successive pixels neighboring each other at the boundary between the two respective units of print data, applying the third unit pulse signal to the print data and counting the number of clock cycles of the third unit pulse signal up to the start and the end positions of the detected pixels.

5. The image forming apparatus of claim 3, wherein the output signal generation unit generates the output signal by transmitting the masking signal and the print data through an OR-gate.

6. The image forming apparatus of claim 2, wherein the output signal generation unit generates the output signal by applying the first and second unit pulse signals to the print data, generating masking signals for the first and second unit pulse signals, and then applying the respective masking signals to the print data.

7. A method of generating an output signal, comprising:
generating a plurality of unit pulse signals having frequencies which are multiples of a reference clock signal when print data having a higher resolution than a reference resolution is inputted;
dividing the print data into plural units by applying the plurality of unit pulse signals to the print data;
detecting successive pixels neighboring each other at a boundary between two of the respective units of print data; and
generating an output signal so that the successive pixels detected at the boundary form one dot.

8. The method of claim 7, wherein the generating of the plurality of unit pulse signals comprises generating a first unit pulse signal having a frequency that is ½ times a frequency of the reference clock signal, a second unit pulse signal obtained by delaying the first unit pulse signal by a ½ period of the reference clock signal, and a third unit pulse signal having a frequency that is four times the frequency of the reference clock signal.

9. The method of claim 8, wherein the generating of the output signal comprises generating a masking signal to form the successive pixels into the one dot and then applying the masking signal to the print data.

10. The method of claim 9, wherein the generating of the output signal further comprises determining a start position, an end position and a size of the masking signal by applying the first and second unit pulse signals to the print data, detecting the successive pixels neighboring each other at the boundary between the two respective units of the print data using the applied first and second unit pulse signals, applying the third unit pulse signal to the print data, and counting the number of clock cycles of the third unit pulse signal up to the start and the end positions of the detected pixels.

11. The method of claim 9, wherein the generating of the output signal comprises transmitting the masking signal and the print data through an OR-gate.

12. The method of claim 8, wherein the generating of the output signal comprises applying the first and second unit pulse signals to the print data, generating masking signals for the first and second unit pulse signals, and then applying the respective masking signals to the print data.

13. An image forming apparatus comprising:
an image controller to generate an output signal by applying a masking signal to print data having a higher resolution than a reference resolution when the print data is inputted to the image forming apparatus; and
an engine unit to print successive pixels neighboring each other at a boundary between respective units of the print data, in accordance with the generated output signal, as one dot.

14. The image forming apparatus of claim 13, wherein the image controller divides the print data into the respective units of the print data by applying a plurality of unit pulse signals to the print data, and detects the successive pixels neighboring each other at the boundary between the respective units of the print data.

15. The image forming apparatus of claim 14, wherein the image controller generates the output signal by generating a masking signal for the detected successive pixels and then transmitting the generated masking signal and the print data through an OR-gate.

16. An image forming apparatus comprising:
an output signal generation unit to detect successive pixels neighboring each other at a boundary between two respective units of print data, and to generate a masking signal covering an area which would be empty space between two dots which would be formed according to the two pixels, so that the successive pixels detected at the boundary form one dot,
wherein each unit of print data has more than one pixel per period of a reference clock signal used to divide the input print data into the print units.

17. The image forming apparatus of claim 16, further comprising:
a clock generation unit to generate the reference clock signal and a plurality of unit pulse signals having frequencies which are multiples of the reference clock signal.

18. The image forming apparatus of claim 17, wherein the output signal generation unit determines a start position, an end position, and a size of the masking signal by applying first and second unit pulse signals to the print data, detecting the successive pixels neighboring each other at the boundary between the two respective units of print data using the applied first and second unit pulse signals, applying the third unit pulse signal to the print data, and counting the number of clock cycles of the third unit pulse signal up to the start and the end positions of the detected pixels.

19. An image forming method, comprising:
detecting successive pixels neighboring each other at a boundary between two respective units of print data; and
generating a masking signal covering an area which would be empty space between two dots which would be formed according to the two pixels, so that the successive pixels detected at the boundary form one dot,
wherein each unit of print data has more than one pixel per period of a reference clock signal used to divide the input print data into the print units.

20. The image forming method of claim 19, further comprising determining a start position, an end position, and a size of the masking signal by applying first and second unit pulse signals to the print data, detecting the successive pixels neighboring each other at the boundary between the two respective units of print data using the applied first and second unit pulse signals, applying the third unit pulse signal to the print data, and counting the number of clock cycles of the third unit pulse signal up to the start and the end positions of the detected pixels.

21. An image forming apparatus comprising:
a clock generation unit to generate a plurality of unit pulse signals to detect successive pixels neighboring each other at a boundary between two units of print data inputted to the image forming apparatus; and
an output signal generation unit to apply a masking signal to the input print data to remove a brightness deviation between dots corresponding to the input print data, wherein the masking signal is based on a detection result of the plurality of unit pulse signals.
